(19) United States
(12) Patent Application Publication
(10) Pub. No.: US 2007/0088161 A1
(43) Pub. Date: Apr. 19, 2007

(54) Novel chelated bisphosphonates for use as pharmaceutical agents

(76) Inventors: Richard F. Stockel, Bridgewater, NJ (US); Edward G. Budnick, Flemington, NJ (US)

Correspondence Address: RICHARD F. STOCKEL, 475 ROLLING HILLS ROAD, BRIDGEWATER, NJ, 08807, US

(21) Appl. No.: 11/254,012

(22) Filed: Oct. 19, 2005

(51) Int. Cl. C07F 9/6512; C07F 9/6503; C07F 9/6506

(52) U.S. Cl. 546/22; 548/118; 548/115; 562/21

(57) ABSTRACT

The present invention is directed to novel calcium and/or magnesium chelated bisphosphonates, which have improved bioavailability, and less irritation in the GI tract. These bioactive chelated bisphosphonates are useful to treat osteoporosis and other medical disorders previously suggested in the literature.

When a metal ion combines with an electron donor, the resulting substance is said to be a complex or coordination compound. If the substance which combines with the metal contains two or more donor groups so that one or more rings are formed, the resulting structure is said to be a chelate compound or metal chelate and the donor is said to be a chelating agent.

The electron pair formed between the electron-accepting metal and the electron-donating complexing or chelating agent, may be essentially ionic or essentially covalent depending on the metals and donor atoms involved.

The chemical and physical properties of metal chelates differ from those of the free metal or metal salts or non-chelated metal compounds and the chelates thus are considered as a distinct class of compounds with characteristic behavior.

Invention

New and improved pharmaceutical compounds for use in osteoporosis and other medical disorders including Paget's disease and other maladies for which disphosphonates have previously been prescribed or suggested.

Previously, bisphosphonates such as Fosamax, etc., have been approved for clinical use in treating osteoporosis, Paget's disease, hypercalcemia or malignancy, etc. The major disadvantage of the clinically utilized bisphosphonate is their poor oral absorption from the GI tract. Typically less than 1% is absorbed. In addition, the bisphosphonates have been associated with adverse gastrointestinal effects in humans. The challenge for novel drug delivery systems is to achieve improved bioavailability and safety. Typical for the novel substituted bisphosphonates is a selective desire and controlled action providing for better therapeutic application. With concomitant reduction of the common side effects of all previously used or prescribed bisphosphonates such as 1) irritation of esophagus, 2) poor absorption, 3) low lipophilicity, 4) rapid injection can lead to renal failure. The compounds of the present invention are for new and improved bisphosphonates with better absorption and less side effects. This has been accomplished by forming chelates of the following bisphosphonates:
a) Alendronate
b) Etidronate
c) Pamidronate
d) Risedronate
e) Tiludronate
f) Ibandronate
g) Zolendronate
h) Iodronate
i) [1-hydroxy-3-(1-pyrrolidinyl)-propylidene]bisphosponate
j) incadronate
k) minodronate
l) neridonrate
m) olpadronate
n) cimadronate
o) clodronate

The free acid or mono or di acid esters of the bisphosponate can be used as starting material and then fully neutralized with an alkali hydroxide, ammonium hydroxide or a neutralizing organic water-soluble amine and then complexed with calcium and/or magnesium salt to form a chelate structure, or netralized with calcium hydroxide or oxide, or magnesium hydroxide or oxide, or combinations of calcium/magnesium hydroxides or oxides.

Calcium and magnesium are two essential elements required for good health.

The bones serve as a storage place for mineral salts and play an important role in the formation of blood cells. They also give shape to and support the body. Calcium deficiency can cause tooth decay, muscle cramps, nervousness, restlessness, insomnia and loss of resistance against infections, poor circulation, bronchitis and colds, among many others. High intake of meat can lead to mineral imbalance, too much phosphorus and too little calcium, which leads to calcium and magnesium deficiency and will result in loss of teeth through decay and pyorrhea. Systems of calcium deficiency are brittle bones, poor development of bones and teeth, rickets hyper-irritability, and excessive bleeding.

Restlessness, insomnia muscle cramps back and leg pains, even asthma and hay fever are systems of calcium deficiency. Recently, a medical researcher said calcium deficiency is the major cause of high blood pressure.

Magnesium should be in the formula from about 1:2 to about 0.25:1.00 amount of calcium in order to be effective. Magnesium has several additional benefits. It helps convert blood sugar into usable energy. It helps vitamins work effectively. It neutralizes stomach acids. Birth control pills and alcohol decreases magnesium in the body. It helps in resisting depression and could prevent kidney stones and calcium deposits. Calcium and magnesium are very beneficial for the heart especially arrhythmias, angina and heart weakness.

Another aspect to this invention is the addition of a organic, non-alkaline ion, chelating agent, which also improves the bioavailability and lowers the toxicity of the active bisphosphonate drugs.

U.S. Pat. No. 6,677,320 32 teaches a method of treatment and prevention of diseases involving bone resorption, especially osteoporosis, which involves a parenteral composition consisting of a bisphosphonate and a pharmaceutical acceptable chealting agent like ethylenediaminetetraacetic acid or diethylenetriaminepentaacetic acid and the like. These are also known as enhancing agents. The molar ratio of the chealated bisphosphonate to EDTA or DTPA found to be effective was form about 1:0.1 to about 1:10.0 with 1:0.5 to about 1:5.0 being preferred.

Other enhancing agents useful for the calcium/magnesium chelated bisphosphonates include (not all inclusive) EGTA, HEDTA, NTA, triethanolamine, 8-hydroxyquinoline, citric acid, tartaric acid, lecithin, glycine, phenylalanine, tryptophan, glycerin, sorbitol, pyrophosphoric acid, and metaphosphoric acid.

The compositions of this invention are true alkaline chelates of various bioactive bisphosphonates, which are useful for the treatment of osteoporosis and other bone diseases. By preparing chelates, not salts of bisphosphonates, the therapeutic value is enhanced due to an increase in lipophilicity and by a slow release of the bisphosphonate under acid conditions found in the stomach. Furthermore, irritation of the GI tract is greatly reduced by the use of these chelated bisphosphonates, since they are alkaline.

Prior Art

U.S. Pat. No. 3,617,575 describes the preparation of polyvalent cation chelates with esters of ethane biphosphonate acid compounds. It was found that two moles of calcium ion chelated with the triphosphonate ester.

Ushtman describes in the Journal of Physical Chemistry, Vol. 76, No. 9, p 1304-1310, 1972 the reaction of calcium ion with ethane-1-hydroxy-1,1-diphophonate to give polynuclear complexes. This is a calcium salt of the bisphosphonate which forms a bridge between the organic substrate. It is not a chelate.

The effect of calcium ion was reported in the International J. of Pharmaceuticals Vol. 213, pp. 135-142 (2001) using mono, di, or triphenyl esters of clodronate (dichloromethylene bisphosphonates). However, the calcium ion chelates of these derivatives were not disclosed.

Chelates of dichloromethylene bisphosphonic acid PP′-diethyl ester was reported in the J. Chem. Soc. Dalton, Trans., 2002 (9), 1969-1973. The magnesium—ligand molar ratio was 2:1, while the calcium—ligand was 1:1.

Fernandez, et al reported the preparation of calcium and zinc complexes of 3-amino-1-hydroxypropylidene bisphosphonate appearing in Acta Crystallogrop-hica. Section c, Vol. 58 pp 494-7, 2002, and Acta Crystallographica, Section C. Vol. 59, pp 228-230, 2003.

Yet in another report, Inorganica Chemica Acta 339 (2002), 111-118 ferric and aluminium ions were chelated with 1-phenyl-1-hydroxymethylene bisphosphonate were prepared, but they existed only at acidic conditions. When the pH was raised above 9 spectroscopic evidence indicated the disappearance of the chelates.

Thus the literature does not anticipate our invention of preparing calcium and magnesium chelates of the bioactive bisphosphonates, alendronate clodronate, [1-hydroxy-3-(1-pyrrolidinyl′)-propylidene]bisphosphonate, etidronate, ibandronate, incadronate, minodronate, neridronate, olpadronate, pamidronate, risedronate, tiludronate, or zoledronate at a pH of 10±0.5 in an alkaline aqueous solution, where all four ionizable bisphosphonate hydrogens are dissociated into the conjugate base.

### EXPERIMENTAL

The general method for the preparation of calcium and magnesium ions chelated with bisphosphonates was carried out using calmagite as the metal ion indicator and the measurement of pH with a Cole-Parma pH/mV/RelmV/°C benchtop meter.

Calmagite is 1-(1-hydroxy-4-methyl-2-phenylazo)-2-naphthol-4-sulfonic acid. Calmagite which when bound to calcium forms a pink complex and when not bound to calcium forms a blue complex.

Procedure

A known amount of a bisphosponate was added to an aqueous solution having a pH of 10.0±0.1. Then a known amount of calcium or magnesium ion, as the titrant, was added while adding 0.1N sodium hydroxide to maintain the pH at 10.0±0.1. Until there is a color change from a blue to a pink color. At this end-point a precipitates appears. The indicator used is calmagnite, which changes color from blue to wine red when free calcium ion appears in solution. Prior to the precipitation an essentially water-soluble chelated bisphosphonate is formed, isolated by concentration to dryness of the filtrate.

Examples of alkaline ion/bisphosphonate molar ratio:
Mg⁺²/ Dequest 2010 (1-hydroxyethylidene-1,1-diphosphonic acid)
1:1 molar ratio
Mg⁺²/ alendronate
1:2 molar ratio
Mg⁺²/risedronate
1:2 molar ratio
Ca⁺²/Dequest 2010
1:2 molar ratio
Ca⁺²/clodronate
1:2 molar ratio
Ca⁺²/1-hydroxyethylidene-1,1-diphosphonic acid, P—P1-diethyl ester
1:2 molar ratio
Ca⁺²/Fasamax
1:1 molar ratio
Ca⁺²/Fesamax
1:4 molar ratio
Ca⁺²/Fosamax
1.5:1 molar ratio

Through detailed experimentation, it has been found that water-soluble Ca⁺² or Mg⁺² chelates can be formed from bioactive bisphosphonates. Useful water-soluble Ca⁺² or Mg⁺² chelates have a alkaline ion: bisphosphonate molar ratios of from about 1:4 to about 1:2.

Interestingly when the Ca⁺² and/or Mg⁺² ion concentration exceeds 1.50 or slightly less or greater in the range of about 1.3 to about 1.75 a precipitate begins to appear with a corresponding change in the indicator, calmagnite, from blue to wine red.

By carefully controlling the alkaline metal cation to the bioactive bisphosphonate it is possible to obtain both water-soluble, water-insoluble, or both types of chelated compositions.

The water-soluble chelated bisphosphonates of this invention are isolated by concentrating the filtrate to dryness prior to a precipitate forming upon the addition of excess calcium and/or magnesium beyond the chelation level. These compositions tend to be water-soluble.

When the calcium and/or magnesium ion concentration exceeds the chelation level a water insoluble salt of the bisphosphonate will precipitate from an aqueous solution. Under these conditions the concentration of the alkaline metal ions will be higher than the more water-soluble chelated bisphosphonates.

Examples of Parenteral Compositions, whereby the drug dosage has both the alkaline metal ions as well as the enhancing agent.

| | | |
|---|---|---|
| Alendronate | 1.20 | mg |
| EDTA, Na₂•2H₂O | 10.00 | mg |
| NaCl | 9.00 | mg |
| NaOH q.s. to | pH | 9.0 |
| H₂O for injection q.s. to | 1.0 | ml |

* the molar ratio of bisphosphonate: Ca⁺²:Mg⁺² is 1:0.8:0.12

| | | |
|---|---|---|
| etidronate* | 1.50 | mg |
| DTPA | 9.00 | mg |
| NaCl | 9.00 | mg |
| NaOH q.s. to | p.H | 9.5 |
| H₂O for injection q.s. to | 1.0 | ml |
| H₂O for injection q.s. to | 1.0 | ml |

*the molar ratio of bisphosphonate: Ca⁺²:Mg⁺² is 1:0.75:0.25

| | | |
|---|---|---|
| Ibandronate* | 1.30 | mg |
| EDTA, Na₂•2H₂O | 10.00 | mg |
| NaCl | 9.00 | mg |
| NaOH q.s. to | pH | 10.0 |
| H₂O for injection q.s. to | 1.0. | ml |

*the molar ratio of bisphosphonate: Ca⁺²:Mg⁺² is 1:0.75:0.25

We claim:

1. Chelates comprising calcium, or magnesium separately, or combinations thereof with bioactive bisphosphonates.

2. Bioactive bisphosphonate chelates as described in claim 1 whereby said bisphosphonates can be one or more comprising alendronate, etidronate, pamidronate, risedronate, tiludronate, ibandronate, zolandronate, clodronate, [1-hydroxy-3-)1-pyrrolidinyl)propylidene]bisphosphonate, incadronate, minodronate, neridronate, olpadronate, cimadronate, or clodronate.

3. Bisphosphonates as described in claim 2 whereby the bisphosphonate can be in the di, tri, or tetra anionic form.

4. Bisphosphonates as described in claim 3 can be neutralized, prior to chelation, with sodium hydroxide, potassium hydroxide, magnesium hydroxide or oxide, calcium hydroxide or oxide, ammonium hydroxide, or pharmaceutically acceptable organoamines.

5. A process to prepare calcium or magnesium chelates or combinations thereof of bioactive bisphosphonates whereby the bisphosphonate is titerated with a magnesium and/or calcium salt hydroxide solutions at a pH of about 8 to 11, preferably about 9.5 to 10.5 pH.

6. A process as described in claim 5 whereby the bioactive bisphosphonates are alendronate, etidronate, pamidronate, risedronate, tiludronate, bandronate, zolandronate, clodronate, [1-hydroxy-3-1-pyrrolidinyl)-propylidene]bisphosphonate, incadronate, minodronate, neridronate, olpadronate.

7. A composition comprising a chelated bisphosphonate as described in claim 1 and a pharmaceutically acceptable chelating agent.

8. The position according to claim 7 wherein the pharmaceutically chelating agent is selected from the group consisting of EDTA, DTPA, EGTA, HEDTA, NTA, triethanolamine, 8-hydroxyquionoline, citric acid, tartaric acid, gluconic acid, saccharic acid, lecithin, phenylalanine, tryptophan, glycerin, sorbitol pyrophosphoric acid, metaphosphoric acid, and other condensed phosphonates as well as bisphosphonates or combinations thereof.

9. The composition according to claim 7 wherein the molar ratio between the bisphosphonate and the pharmaceutically acceptable chelating agent(s) from about 1.0:0.1 to about 1.0:10.0.

10. A method for the treatment and prevention of diseases involving bone resorption, especially osteoporosis, Paget's disease, hypercalcemia of malignancy, and metabolic bone disease comprising the step of administering to a patient transthermally, parenterally, and orally, and the like, a composition as claimed in claim 1 or claim 7.
